(19) United States
(12) Patent Application Publication
(10) Pub. No.: US 2018/0239175 A1
(43) Pub. Date: Aug. 23, 2018

(54) DISPLAY PANEL, DISPLAY DEVICE AND MANUFACTURING METHOD

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventor: Yan WANG, Beijing (CN)

(21) Appl. No.: 15/553,203

(22) PCT Filed: Mar. 1, 2017
(86) PCT No.: PCT/CN2017/075347

§ 371 Date: Aug. 24, 2017

(30) Foreign Application Priority Data
Jun. 27, 2016 (CN) 201610482849.6

(51) Int. Cl. G02F 1/00; G02F 1/1339; G02F 1/1333

(52) U.S. Cl. CPC G02F 1/0045; G02F 2001/133311; G02F 1/133308; G02F 1/1339

(57) ABSTRACT

A display panel includes an array substrate and an opposing substrate provided oppositely, a liquid crystal, and a compensation structure directly contacting the liquid crystal and having a property of cold expansion and heat contraction, wherein the compensation structure is configured to compensate for a volume change of the liquid crystal under the condition of the liquid crystal being expanded or contracted, such that a cell gap of the display panel remains unchanged. A compensation structure having a property of cold expansion and heat contraction is provided in the liquid crystal of the display panel.

### CROSS REFERENCE

The present application is based upon International Application No. PCT/CN2017/075347, filed on Mar. 1, 2017, which is based upon and claims priority to Chinese Patent Application No. 201610482849.6, filed on Jun. 27, 2016, and the entire contents thereof are incorporated herein by reference.

### TECHNICAL FIELD

The present disclosure relates to a field of display panel, and more particularly, to a display panel, a display device, and a manufacturing method.

### BACKGROUND

At present, a TFT-LCD (Thin Film Transistor Liquid Crystal Display) has advantages of small volume, low power consumption, no radiation, etc., which has been developed rapidly in recent years, has become the mainstream of the display in the market, and is widely used in mobile phones, tablets, notebooks and other electronic apparatuses.

In order to meet the usage under various environments, quality of a liquid crystal panel needs to be evaluated. In the process of quality evaluation, various tests under high temperature and low temperature environment need to be carried out. Under the high temperature condition, the liquid crystal volume within the liquid crystal panel cell expands, and the redundant liquid crystal will be accumulated at a lower side of the panel, which will lead to the periphery yellowing phenomenon caused by a high cell gap. Under the low temperature test condition, the liquid crystal volume in the liquid crystal panel cell contracts, resulting in bubble defect. Considering the deviation among the drops of the liquid crystal in the production line, while designing a columnar spacer of the color film substrate, it is necessary to ensure proper density of the spacer. If the density is too large, after forming a cell assembly, the spacer will not have a compression amount large enough to prevent the bubble defect when the liquid crystal volume contracts at low temperatures. While, if the density is too small, a superior strength of the liquid crystal cell will not be maintained. After the cover plate is bonded, it is very likely to generate the water ripple defect. The density design of the columnar spacer encounters great difficulty and challenge.

It should be noted that, information disclosed in the above background portion is provided only for better understanding of the background of the present disclosure, and thus it may contain information that does not form the prior art known by those ordinary skilled in the art.

### SUMMARY

Embodiments of the present disclosure provide a display panel, a display device and a method for manufacturing the same.

According to an embodiment of the present disclosure, there is provided a display panel including an array substrate and an opposing substrate provided oppositely, and a liquid crystal provided between the array substrate and the opposing substrate, wherein the display panel further includes: a compensation structure directly contacting the liquid crystal and having a property of cold expansion and heat contraction, wherein the compensation structure is configured to compensate for a volume change of the liquid crystal under the condition of the liquid crystal being expanded or contracted, such that a cell gap of the display panel remains unchanged.

According to an embodiment of the present disclosure, there is provided a display device including the above-described display panel provided by embodiments of the present disclosure.

According to an embodiment of the present disclosure, there is provided a method of manufacturing the above display panel provided by embodiments of the present disclosure. The method includes:

depositing a film layer having a property of cold expansion and heat contraction in a region of the first substrate directly contacting the liquid crystal;

coating a photoresist on the film layer;

performing exposure and development processing on the photoresist through a pattern of a mask plate;

etching the film layer; and

peeling off the remaining photoresist, to form the compensation structure,

wherein the compensation structure is configured to compensate for a volume change of the liquid crystal under the condition of the liquid crystal being expanded or contracted, such that a cell gap of the display panel remains unchanged.

It is to be understood that both the foregoing general description and the following detailed description are exemplary and explanatory only and are not restrictive of the invention, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

The accompanying drawings are enclosed to provide a further understanding of the present disclosure and constitute a part of the specification, and together with the following detailed description, to serve for explanation of the present disclosure. But the accompanying drawings are not to be construed as limiting the present disclosure. In the drawings:

FIG. 1 is a schematic structural view of a first display panel according to an embodiment of the present disclosure;

FIG. 2 is a schematic structural view of a second display panel according to an embodiment of the present disclosure; and

FIG. 3 is a top view of a compensation structure in the display panel provided in the embodiment of the present disclosure.

### DETAILED DESCRIPTION

The technical solutions described in the embodiments of the present disclosure will now be described in conjunction with the accompanying drawings in the embodiments of the present disclosure. It is apparent that the described embodiments are only part embodiments of the present disclosure and are not intended to be exhaustive. Based on embodiments in the present disclosure, all other embodiments obtained by those of ordinary skill in the art without making creative work are within the protection scope of the present disclosure.

The thickness and size of respective film layers in the drawings do not represent the actual proportions of the sealants, the purpose of which is merely illustrative of contents of the present disclosure.

At present, in the process of quality evaluation of the liquid crystal panel, a variety of tests under high temperature and low temperature environment need to be carried out. Due to the heat expansion and cold contraction property of the liquid crystal, the liquid crystal volume in the liquid crystal panel cell will change, which in turn leads to bubble defect or water ripple defect of the display panel. The above problem will not be solved excellently only through the density of the spacer.

According to at least one of the following embodiments of the present disclosure, there is providing a display panel, a display device and a method for manufacturing the same, to solve the problem that at present, in the process of quality evaluation of the liquid crystal panel, a variety of tests under high temperature and low temperature environment need to be carried out, and due to the heat expansion and cold contraction property of the liquid crystal, the liquid crystal volume in the liquid crystal panel cell will change, which in turn leads to bubble defect or water ripple defect of the display panel, and the above problem will not be solved excellently only through the density of the spacer

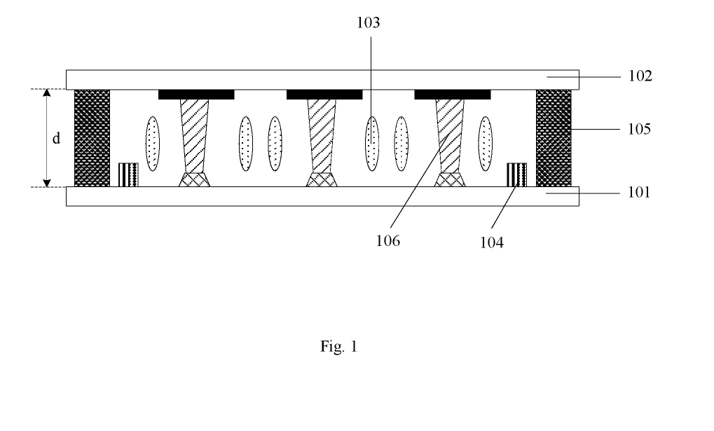

FIG. 1 is a schematic structural view of a first display panel according to an embodiment of the present disclosure, which includes an array substrate 101 and an opposing substrate 102 provided oppositely, and a liquid crystal 103 provided between the array substrate and the opposing substrate. The display panel further includes: a compensation structure 104 directly contacting the liquid crystal 103 and having a property of cold expansion and heat contraction, wherein the compensation structure 104 is configured to compensate for a volume change of the liquid crystal 103 after the liquid crystal 103 is expanded or contracted, such that a cell gap d of the display panel remains unchanged

In a specific implementation, the display panel provided by the embodiment of the present disclosure mainly includes a liquid crystal cell including an array substrate 101, an opposing substrate 102, a liquid crystal 103 filled between the two substrates, and a sealant 105. In the embodiment, the liquid crystal cell is supported by a pillar spacer 106 at the substrate side. Except that the compensation structure 104 is provided at a position where it can contact with the liquid crystal 103, the other respective film layers may refer to the display panel of the prior art. Specifically, since the compensation structure 104 is for compensating for the expanded or contracted volume of the liquid crystal when the quality of the display panel is evaluated, the compensation structure 104 must directly contact the liquid crystal 103, and the specific position thereof may be selected as needed, as long as the display effect and normal operation of the display panel will not be affected.

Further, under high and low temperature test conditions, since the liquid crystal 103 has the heat expansion and cold contraction property, the compensation structure 104 needs to have a contrary property, i.e., the cold expansion and heat contraction property, in order to effectively compensate for the volume of the liquid crystal. When the quality of the display panel is evaluated, the volume change of the liquid crystal under high and low temperature test conditions may be effectively compensated for by adjusting the amount of the compensation structure 104, such that the cell gap d of the display panel remains unchanged, which avoids the bubble defect and the yellowing defect caused by a large liquid crystal volume occurring in the high and low temperature tests of the display panel. Meanwhile, there is no need to change the density of the spacer to solve the above problems, which increases the design margin of a columnar spacer and the compatibility of the panel for the fluctuation of the production process.

In the embodiment, in order not to affect the display effect of the display panel, when the volumes of the liquid crystal 103 and the compensation structure 104 change under high and low temperature test conditions, the change in the cell gap of the display panel will not be affected. That is, the volume of the compensation structure 104 after being expanded and contracted may compensate for the volume change of the liquid crystal 103 after being contracted or expanded, without affecting the cell gap d of the display panel.

It is mainly because the volume change amounts of the liquid crystal 103 and the compensation structure 104 may be mutually compensated for, the volumes of the compensation structure 104 after being expanded and contracted will not affect the cell gap d of the display panel. Specifically, it is necessary to select the amount of the compensation structure 104 according to the expanded and contracted volumes of the liquid crystals. Preferably, an amount of the volume change of the compensation structure after being expanded with cold is not larger than an amount of the volume change of the liquid crystal after being contracted with cold at the same temperature. Further, preferably, an amount of the volume change of the compensation structure 104 after being contracted with heat is no less than an amount of the volume change of the liquid crystal after being expanded with heat at the same temperature.

In the specific implementation, when the low temperature test is carried out, the compensation structure 104 expands with cold, while the volume of the liquid crystal contracts with cold, in order to maintain an original cell gap of the display panel as much as possible, the volume change amount of the expanded compensation structure 104 should be equal to the volume change amount of the contracted liquid crystal to the greatest extent, but cannot be larger than the volume change amount of the contracted liquid crystal. When the high temperature test is carried out, the compensation structure 104 contracts with heat, while the liquid crystal expands with heat, in order to maintain an original cell gap of the display panel as much as possible, the volume change amount of the contracted compensation structure 104 should be equal to the volume change amount of the expanded liquid crystal to the greatest extent, but cannot be smaller than the volume change amount of the expanded liquid crystal.

For example, in a specific implementation, the expansion volume V₁ and the contraction volume V₂ of the liquid crystal in the display panel under high and low temperatures may be calculated from the calculated volume of the liquid crystal in the liquid crystal cell and the expansion coefficient of the liquid crystal under high and low temperatures; and the required volume V₃ of the compensation structure 104 may be calculated according to the expansion volume V₁, the contraction volume V₂, and the expansion and contraction coefficients of the compensation structure 104. During the manufacturing of the film layers of the display panel, the compensation structure 104 is formed with a corresponding shape to ensure that the volume of the compensation structure 104 is equal to V₃, so that the display panel defect caused by the volume change of the liquid crystal at high and low temperatures may be effectively compensated for.

In the manufacturing process of the display panel, the compensation structure 104 having the property of cold expansion and heat contraction may be manufactured in the non-display region of the display panel by deposition, exposure, etching or the like, thereby completing the compensation for the volume change of the liquid crystal. Of course, on the premise that the display effect will not be affected, the manufacture of the compensation structure may also be performed in the display region. The position of the compensation structure 104 is described in detail below.

In a specific implementation, the compensation structure 104 may be provided at any position that can directly contact the liquid crystal as required, provided that the setting of the compensation structure 104 does not affect the display effect, normal operation and thickness or the like of the display panel. Preferably, the compensation structure 104 is provided on the array substrate and/or the opposing substrate. As shown in FIG. 1, the compensation structure 104 is provided on the array substrate, and it may be also provided on the opposing substrate as needed, or provided on both of the substrates.

Further, the setting of the compensation structure 104 cannot affect the display effect of the display panel, and therefore, it may be provided in a region of the non-display region where it can contact with the liquid crystal, or a position in the display region where the display is not affected. Preferably, the compensation structure 104 is provided in a display region and/or the non-display region. Preferably, the compensation structure 104 is provided in a non-opening region of the display region. For example, FIG. 2 is a schematic structural view of a second display panel according to an embodiment of the present disclosure. Since the display panel includes a black matrix 107, the compensation structure 104 may be provided in the display region as needed, i.e., compensation structure 104 is disposed such that an orthographic projection thereof on the display panel may be located within the orthographic projection of the black matrix on the display panel.

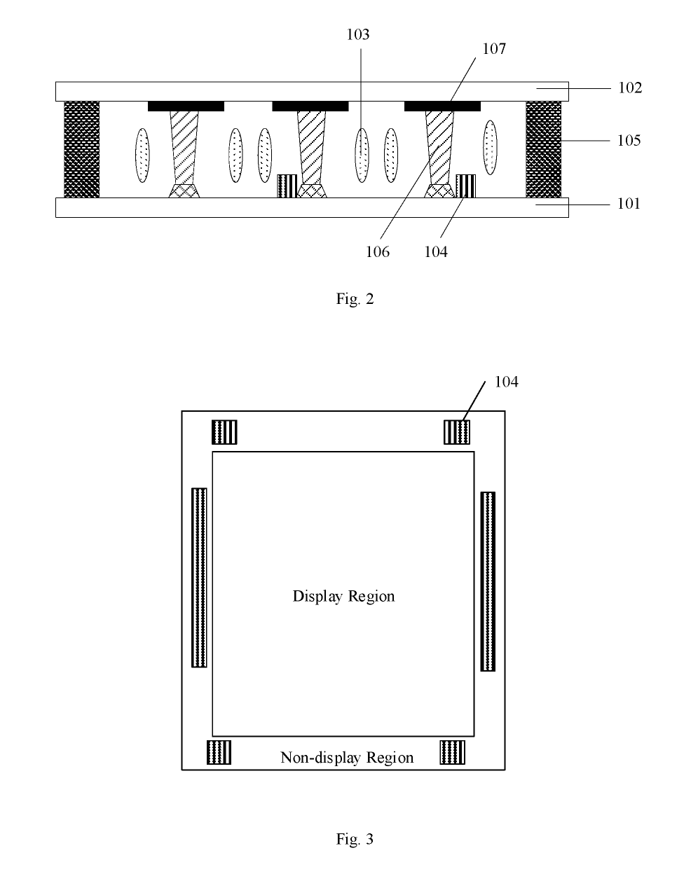

In a specific implementation, the shape of the compensation structure 104 may not be limited and may be set as desired. Preferably, the shape of the compensation structure 104 is a cuboid or a cube. FIG. 3 is a top view of a compensation structure in the display panel provided in the embodiment of the present disclosure. In the embodiment, the compensation structure 104 is provided in a non-display region and can be set as an arbitrary shape as required. However, for ease of manufacture, and for being able to be manufactured together with the metal wiring of the display panel, the shape of the compensation structure 104 is set as a cuboid or a cube. FIG. 3 is a top view thereof, which includes the compensation structures 104 of four cubes and two cuboids. In actual manufacture, the number, position, volume, etc. of the compensation structure 104 may be set as required, as long as the compensation structure 104 may directly contact the liquid crystal 103 without affecting the display effect and the normal operation of the display panel.

As for the selection of the compensation structure 104, in addition to the above definition of the relationship with the volume of the liquid crystal, the height of the expanded compensation structure 104 will preferably not affect the cell gap of the display panel, that is, the height of the expanded compensation structure 104 is no more than cell gap of the display panel, and specific values may be selected as needed. Preferably, the height of the compensation structure 104 is no more than about 1 μm.

In a specific implementation, the compensation structure 104 provided by the embodiment of the present disclosure has the property of cold expansion and heat contraction. The suitable material may be selected as needed, so long as it has the property of cold expansion and heat contraction. Preferably, the material of the compensation structure 104 is any one of the following materials or a combination thereof: gallium (Ga), antimony (Sb) or bismuth (Bi). The compensation structure 104 may include a single material or a mixture, in order to satisfy that the volumes of the expanded and contracted compensation structure 104 do not affect the cell gap of the display panel.

Based on the same inventive concept, an embodiment of the present disclosure provides a display device including the above-described display panels according to embodiments of the present disclosure. Since the principle to solve problems of the display device is similar to that of the above-described display panel, the implementation of the display device may refer to the implementation of the above-described display panels, and the repetition will not be repeated.

Based on the same inventive concept, an embodiment of the present disclosure provides a method of manufacturing the above-described display panels provided in embodiments of the present disclosure, including: forming a first substrate; forming at least one compensation structure having a property of cold expansion and heat contraction on the first substrate; forming a second substrate opposite to the first substrate; and forming a liquid crystal layer between the first substrate and the second substrate, to form a liquid crystal cell of the display panel, wherein the compensation structure directly contacts the liquid crystal in the liquid crystal layer, and the compensation structure is configured to compensate for a volume change of the liquid crystal after the liquid crystal is expanded or contracted, such that a cell gap of the display panel remains unchanged.

More specifically, according to the present embodiment, at least one compensation structure having a property of cold expansion and heat contraction may also be formed on the second substrate, before a second substrate opposite to the first substrate is formed.

According to some embodiments of the present disclosure, at least one compensation structure having a property of cold expansion and heat contraction may be formed by the following method: depositing a film layer having a property of cold expansion and heat contraction in a region of the first substrate directly contacting the liquid crystal; coating a photoresist on the film layer; performing exposure and development processing on the photoresist through a pattern of a mask plate; etching the film layer; and peeling off the remaining photoresist, to form the compensation structure.

An example of using an etching method to form the compensation structure has been described above. However, the present disclosure is not limited thereto, other etching methods such as plasma etching may also be adopted to form the compensation structure. In addition, the compensation structure is not limited to be formed by using the etching method, it may also be formed by a method such as deposition. For example, according to an embodiment of the present disclosure, forming at least one compensation structure having a property of cold expansion and heat contraction includes: depositing the compensation structure in a region of the first substrate directly contacting the liquid crystal by at least one of: physical vapor deposition, chemical vapor deposition, ink jet printing, screen printing, spin coating, sputtering, injection molding, or a combination thereof.

In the present embodiment, the first substrate may be one of an array substrate and an opposing substrate, and the second substrate may be the other of the array substrate and the opposing substrate.

Other aspects of the present embodiment may refer to the foregoing embodiments, and thus the description will not be repeated herein.

In a specific implementation, the method of manufacturing the display panel provided in the above embodiment is only a preferable manufacturing method, and it is also possible to manufacture the display panel by any other means, as long as it is possible to ensure that the compensation structure provided in the display panel may directly contact the liquid crystal, and the volume of the compensation structure may compensate for the volume change of the liquid crystal after being expanded or contracted.

As described above, a compensation structure having a property of cold expansion and heat contraction is provided in the liquid crystal of the display panel according to the embodiment of the present disclosure. When the quality of the display panel is evaluated, since the cold expansion and heat contraction property of the compensation structure is contrary to the heat expansion and cold contraction property of the liquid crystal, the volume change of the liquid crystal under high and low temperature test conditions may be effectively compensated for by adjusting the amount of the compensation structure, so as to the avoid the bubble defect and the yellowing defect caused by a large liquid crystal volume occurring in the high and low temperature tests of the display panel, which increases the design margin of a columnar spacer and the compatibility of the panel for the fluctuation of the production process. Meanwhile, the reliability of the product quality and tolerance of the technological fluctuation may be improved.

Apparently, various amendments and modifications to the present disclosure are possible to those skilled in the art, without departing from the sprite and scope of the present disclosure. As such, the present disclosure intends to involve these changes and modifications to the present disclosure as long as they belong to the scope of claims and its equivalent technical of the present disclosure.

1. A display panel, comprising:
an array substrate;
an opposing substrate provided oppositely with the array substrate;
a liquid crystal provided between the array substrate and the opposing substrate; and
a compensation structure directly contacting the liquid crystal and having a property of cold expansion and heat contraction,
wherein the compensation structure is configured to compensate for a volume change of the liquid crystal under the condition of the liquid crystal being expanded or contracted, such that a cell gap of the display panel remains unchanged.

2. The display panel of claim 1, wherein a height of the compensation structure is no more than about 1 μm.

3. The display panel according to claim 1, wherein an amount of the volume change of the compensation structure under the condition of being expanded with cold is not larger than an amount of the volume change of the liquid crystal under the condition of being contracted with cold at the same temperature.

4. The display panel according to claim 1, wherein an amount of the volume change of the compensation structure under the condition of being contracted with heat is no less than an amount of the volume change of the liquid crystal under the condition of being expanded with heat at the same temperature.

5. The display panel according to claim 1, wherein the compensation structure is provided on at least one of the array substrate and the opposing substrate.

6. The display panel according to claim 1, wherein the compensation structure is provided in at least one of a display region and a non-display region.

7. The display panel according to claim 6, wherein the compensation structure is provided in a non-opening region of the display region.

8. The display panel according to claim 1, wherein a shape of the compensation structure is a cuboid or a cube.

9. The display panel according to claim 1, wherein the compensation structure comprises at least one of: gallium (Ga), antimony (Sb), bismuth (Bi), or a combination thereof.

10. A display device, comprising the display panels according to claim 1.

11. A method of manufacturing a display panel, comprising:
forming a first substrate;
forming at least one compensation structure having a property of cold expansion and heat contraction on the first substrate;
forming a second substrate opposite to the first substrate; and
forming a liquid crystal layer between the first substrate and the second substrate, to form a liquid crystal cell of the display panel,
wherein the compensation structure directly contacts the liquid crystal in the liquid crystal layer, and the compensation structure is configured to compensate for a volume change of the liquid crystal under the condition of the liquid crystal being expanded or contracted, such that a cell gap of the display panel remains unchanged.

12. The method according to claim 11, wherein prior to the step of forming a second substrate opposite to the first substrate, at least one compensation structure having a property of cold expansion and heat contraction is formed on the second substrate.

13. The method according to claim 11 or 12, wherein the step of forming at least one compensation structure having a property of cold expansion and heat contraction comprises:
depositing a film layer having a property of cold expansion and heat contraction in a region of the first substrate directly contacting the liquid crystal;
coating a photoresist on the film layer;
performing exposure and development processing on the photoresist through a pattern of a mask plate;
etching the film layer; and
peeling off the remaining photoresist, to form the compensation structure.

14. A method according to claim 11, wherein the step of forming at least one compensation structure having a property of cold expansion and heat contraction comprises:
depositing the compensation structure in a region of the first substrate directly contacting the liquid crystal by at least one of: physical vapor deposition, chemical vapor deposition, ink jet printing, screen printing, spin coating, sputtering, injection molding.

15. The method according to claim 11, wherein the first substrate is one of an array substrate and an opposing substrate, and the second substrate is the other of the array substrate and the opposing substrate.

16. The method according to claim 11, wherein the compensation structure is formed in at least one of a display region and a non-display region.

17. The method of claim 16, wherein the compensation structure is formed in a non-opening region of the display region.

18. The method according to claim 11, wherein a height of the compensation structure is no more than about 1 μm.

19. The method according to claim 11, wherein the compensation structure is formed as a cuboid or a cube.

20. The method according to claim 1, wherein the compensation structure is formed of at least one of: gallium (Ga), antimony (Sb), bismuth (Bi), or a combination thereof.
